(19) United States
(12) Patent Application Publication
(10) Pub. No.: US 2011/0304716 A1
(43) Pub. Date: Dec. 15, 2011

(54) Optical device for stereoscopic display and stereoscopic display apparatus

(75) Inventors: Yoshihisa Sato, Saitama (JP); Masayoshi Morita, Tokyo (JP); Hiroyuki Nagai, Chiba (JP); Yoshiki Okamoto, Kanagawa (JP)

(73) Assignee: Sony Corporation, Tokyo (JP)

(21) Appl. No.: 13/064,629

(22) Filed: Apr. 5, 2011

(30) Foreign Application Priority Data
Jun. 14, 2010 (JP) 2010-135160

(51) Int. Cl. H04N 13/04; G02F 1/1335; G02B 27/26; G02B 27/22

(52) U.S. Cl. 348/54; 359/466; 349/15; 348/E13.026

(57) ABSTRACT

An optical device for stereoscopic display includes: a display section having a first surface and a second surface opposed to each other and outputting displayed-image light from the second surface; a parallax separation section disposed to face the second surface of the display section, and splitting the displayed-image light from the display section to allow stereoscopy; a first transparent parallel plate disposed to be in contact with the first surface of the display section; and a second transparent parallel plate disposed to be in contact with the second surface of the display section.

### BACKGROUND OF THE INVENTION

1. Field of the Invention

The present invention relates to an optical device for stereoscopic display and a stereoscopic display apparatus, enabling, for example, parallax-barrier-type stereoscopy.

2. Description of Related Art

A technique for stereoscopic display may be classified into two methods, a method with glasses used by a viewer, and a method enabling autostereoscopy without use of glasses by a viewer. The latter display method is called autostereoscopic display method. A typical autostereoscopic display method includes a parallax barrier type and a lenticular lens type. In the parallax barrier type or the lenticular lens type, parallax images (a right-eye image and a left-eye image in the case of two viewpoints) for stereoscopy are displayed on a two-dimensional display panel in a spatially divided manner, and parallax separation of the parallax images is performed in a horizontal direction by a parallax separation section so that stereoscopy is achieved. In the case of the parallax barrier type, a parallax barrier having slit-like openings is used as the parallax separation section. In the case of the lenticular lens type, a lenticular lens having a plurality of cylindrical lenses arranged in parallel is used as the parallax separation section.

Japanese Unexamined Patent Application Publication No. 03-119889 (JP-A-03-119889) discloses a technique using an element with a liquid crystal material as a parallax barrier. In the technique described in JP-A-03-119889, the parallax barrier is electrically changed between a state having both a shading section and openings and a state having openings only, enabling switching between stereoscopic (3D) display and plane (2D) display.

Japanese Unexamined Patent Application Publication No. 2004-294484 (JP-A-2004-294484) discloses a technique for a device having a large display section, in which spacers are used between a video display element having pixels and a parallax barrier. JP-A-2004-294484 proposes that, for a large stereoscopic display apparatus, a spacer member including a glass material different from that of a display panel is disposed between the display panel and the parallax barrier.

Japanese Unexamined Patent Application Publication Nos. 61-32033 and 64-55519 (JP-A-61-32033 and JP-A-64-55519) disclose a technique where sheet glass or a steel plate is set on a glass substrate during manufacturing of a liquid crystal panel so that liquid crystal glass is pressurized to be kept flatness in order to adjust thickness of a liquid crystal layer (gap thickness) to be uniform during the manufacturing. According to the technique, a liquid crystal panel is prevented from being deformed during manufacturing of the panel and thus gap thickness is made uniform, thereby thickness of a liquid crystal layer is made uniform, and consequently a liquid crystal display apparatus with high image quality may be manufactured.

Japanese Unexamined Patent Application Publication No. 08-94968 (JP-A-08-94968) discloses a technique where an optical adjustment layer for preventing reflection or diffusion of light is integrally disposed between a display panel and a parallax barrier.

### SUMMARY OF THE INVENTION

Japanese Unexamined Patent Application Publication (Translation of PCT Application) No. 2000-503424 (JP-T-2000-503424) discloses a technique for a lenticular-lens-type stereoscopic display apparatus, in which a lenticular element is formed of a liquid crystal element.

FIG. 15 shows a concept of parallax-barrier-type stereoscopic display. In a parallax-barrier-type autostereoscopic display method, a display panel 102 is combined with a parallax barrier 101 for stereoscopic display. The parallax barrier 101 has openings 110 and a shading section 111. The display panel 102 has a plurality of pixels (A, B, C, . . . ), each pixel displaying an image in correspondence to a corresponding visual point. Two or more visual points are necessary to achieve stereoscopy. FIG. 15 illustrates a case of five visual points. Light outputted from each pixel of the display panel 102 is limited in forward direction by the openings 110 of the parallax barrier 101. Light from pixels corresponding to the same visual point are outputted from openings 110 of the parallax barrier 101 while being selected in approximately the same direction. Each of two eyes of a viewer 200 receives light from a pixel, related to a visual point, of the display panel 102. The two eyes receive images corresponding to different visual points, and therefore the viewer 200 views a stereoscopic image.

FIG. 16 shows a correspondence relationship between a plurality of openings 110 of the parallax barrier 101 and pixels of the display panel. FIG. 16 shows a correspondence relationship between three openings 1 to 3 (first opening 110-1, second opening 110-2 and third opening 110-3) and fifteen pixels (A, B, C, . . . and O). In FIG. 16, positional relationships between the respective openings 110-1, 110-2 and 110-3 and pixels are approximately the same. For example, a positional relationship between the first opening 110-1 and a pixel A is substantially equal to a positional relationship between the second opening 110-2 and a pixel F and to a positional relationship between the third opening 110-3 and a pixel K. Similarly, a positional relationship between the first opening 110-1 and a pixel C, a positional relationship between the second opening 110-2 and a pixel H and a positional relationship between the third opening 110-3 and a pixel M are substantially equal to one another. Such relationships may be achieved if the parallax barrier 101 and the display panel 102 are flat each, and in a parallel positional relationship.

When a liquid crystal panel as described in JP-A-03-119889 is used as the display panel 102, the following difficulty occurs. In a previous liquid crystal panel, a liquid crystal material is enclosed between thin glass sheets of 0.3 to 1.2 mm thick with a distance of several micrometers from each other. Since the panel includes thin glass sheets bonded to each other, thickness of the panel is approximately 0.6 to 2.4 mm even after bonding, and therefore the panel is weak in stiffness and easily deformed by external force or its own weight.

FIGS. 17 and 18 show a configuration and a display state of the display panel 102 being deformed and distorted. As shown in the figures, when the display panel 102 is deformed, the ideal positional relationships between the respective openings 110-1, 110-2 and 110-3 and pixels as shown in FIG. 16 may be broken. For example, a positional relationship between the first opening 110-1 and a pixel C, a positional relationship between the second opening 110-2 and a pixel H and a positional relationship between the third opening 110-3 and a pixel M are not equal to one another. Specifically, the second opening 110-2 and the pixel H are in a positional relationship where the opening and the pixel are close to each other compared with in other two positional relationships. This is due to deformation of the display panel 102. Actually, not only vertical distances but also horizontal positional relationships are unequal in FIGS. 17 and 18.

When a positional relationship between the opening 110-1, 110-2 or 110-3 of the parallax barrier 101 and a corresponding pixel of the display panel 102 is changed, an angle of a beam, which is selected in angle by the opening 110-1, 110-2 or 110-3, is changed. FIG. 18 shows an aspect where a beam emitted from a pixel of the display panel 102 is selected in emission angle by a corresponding opening in the case that the display panel 102 is distorted. This reveals that positional relationships between the respective openings 110-1, 110-2 and 110-3 and corresponding pixels are different from one another, and therefore a beam angle selected by an opening is varied. In such a state, a visual point corresponding to an image received by each of eyes of the viewer 200 is changed depending on a location of the display apparatus, causing image degradation such as moire or pseudoscopy.

When the parallax barrier 101 is formed of a liquid crystal display element as described in JP-A-2004-294484, as in the case where a liquid crystal panel is used as the display panel 102, each glass sheet forming the parallax barrier 101 is small in thickness and therefore the parallax barrier deflects due to low stiffness, so that the above proper positional relationships are more hardly achieved.

JP-A-2004-294484 describes an issue of a display apparatus described in JP-A-03-119889: for a large display apparatus, since a distance between a display panel and a parallax barrier is large, a spacer member needs to have high transparency and besides cost of the spacer member is disadvantageously increased. In addition, JP-A-2004-294484 describes that each member needs to have high surface flatness (paragraphs [0014] to [0015] of JP-A-2004-294484). As a measure to solve the issues, JP-A-2004-294484 proposes that a spacer member formed of a glass material different from that of a liquid crystal panel for display is disposed between a display panel and a parallax barrier.

However, the method described in JP-A-2004-294484 has the following difficulties. As shown in FIGS. 1A and 1B of JP-A-2004-294484, the display panel and the liquid-crystal parallax barrier are connected to spacer glass at respective surface ends (peripheries). In a display panel having a diagonal more than 10 inches long, even if the periphery of the panel is connected to the spacer glass, the panel may be still deformed at a high possibility. Particularly, since a central portion of the display panel is not supported, the panel may be deformed as shown in FIG. 17 at a high possibility, and consequently the issues may not be solved.

In addition, “flatness of each member” as an issue in JP-A-2004-294484 is described only on a spacer member, and no description is made on flatness of a display panel or a parallax barrier. Accordingly, the technique disclosed by JP-A-2004-294484 is hard to solve the issue of deformation of the display panel or of the parallax barrier formed of a liquid crystal element, leading to image degradation such as moire or pseudoscopy.

According to the related art described in JP-A-61-32033 and JP-A-64-55519, flatness of a glass substrate may be kept and thus gap thickness of a liquid crystal layer may be kept uniform during manufacturing of a liquid crystal panel. However, after the liquid crystal panel has been manufactured, while the gap thickness of a liquid crystal layer interposed between glass substrates may be considerably kept to be uniform, the panel is deformed in such a manner that two glass substrates are distorted in a substantially parallel manner. Therefore, the two glass substrates and the liquid crystal layer are deformed together, and consequently flatness may not be kept. Therefore, even if a liquid crystal panel is manufactured and combined with a parallax barrier or the like by using the technique described in JP-A-61-32033 and JP-A-64-55519, the above issues may not be solved.

In JP-A-08-94968, while an optical member is integrally disposed between a display panel and a parallax barrier, the intermediate optical member is merely an optical adjustment layer for preventing reflection or diffusion of light. Therefore, thickness of the optical adjustment layer is small compared with thickness of each of the display panel and the parallax barrier as shown in FIG. 1 and the like of JP-A-08-94968. As a result, since total thickness of the display panel, the parallax barrier and the optical adjustment layer is small, stiffness is still low, and therefore the display panel and the parallax barrier are deformed together. Consequently, the above issues may not be solved.

While the issues have been described with a case of the parallax barrier type as an example, the same issues occur in a lenticular-type stereoscopic display apparatus as described in JP-T-2000-503424.

It is desirable to provide an optical device for stereoscopic display and a stereoscopic display apparatus, which may suppress deformation of a display section and therefore may perform good stereoscopic display over the whole screen area.

An optical device for stereoscopic display according to a first viewpoint of the invention includes a display section having a first surface and a second surface opposed to each other and outputting displayed-image light from the second surface, a parallax separation section disposed to face the second surface of the display section, and splitting the displayed-image light from the display section to allow stereoscopy, a first transparent parallel plate disposed to be in contact with the first surface of the display section, and a second transparent parallel plate disposed to be in contact with the second surface of the display section. In the invention, “disposed to be contacted” is not limited to a case where the first surface of the display section is directly adhered to the first transparent parallel plate without any other substance in between. For example, a state may be included, where the first surface is adhered to the first transparent parallel plate with a thin film such as an adhesive layer in between, the thin film being sufficiently thin compared with the display section or the first transparent parallel plate.

A stereoscopic display apparatus according to an embodiment of the invention includes an optical device for stereoscopic display, and a signal processor allowing the optical device for stereoscopic display to display images based on inputted video signals, wherein the optical device for stereoscopic display is formed of the optical device for stereoscopic display according to the first viewpoint of the invention.

An optical device for stereoscopic display according to a second viewpoint of the invention includes a light source, a display section having a first surface and a second surface opposed to each other and outputting displayed-image light from the second surface, a parallax separation section disposed between the light source and the first surface of the display section, and splitting the displayed-image light from the display section to allow stereoscopy, a first transparent parallel plate disposed to be in contact with the first surface of the display section, and a second transparent parallel plate disposed to be in contact with the second surface of the display section.

An optical device for stereoscopic display according to a third viewpoint of the invention includes a display section having a first surface and a second surface opposed to each other and outputting displayed-image light from the second surface, a parallax separation section disposed to face the second surface of the display section, and having a light shielding section and a plurality of light-transmissive openings, a first transparent parallel plate disposed to be in contact with the first surface of the display section, and a second transparent parallel plate disposed to be in contact with the second surface of the display section.

In the optical devices for stereoscopic display according to the first to third viewpoints of the invention or the stereoscopic display apparatuses according to the embodiment of the invention, the first transparent parallel plate is disposed to be in contact with the first surface of the display section, and the second transparent parallel plate is disposed to be in contact with the second surface thereof, and therefore the display section is planarly supported by the first transparent parallel plate and the second transparent parallel plate. This suppresses deformation of the display section.

According to the optical devices for stereoscopic display of the first to third viewpoints of the invention or the stereoscopic display apparatuses of the embodiment of the invention, since the display section is planarly supported by the first transparent parallel plate and the second transparent parallel plate, deformation of the display section is suppressed, and consequently good stereoscopic display may be achieved over the whole screen area.

Other and further objects, features and advantages of the invention will appear more fully from the following description.

### BRIEF DESCRIPTION OF THE DRAWINGS

FIG. 1 is a perspective diagram showing a configuration example of an optical device for stereoscopic display according to a first embodiment of the invention.

FIG. 2 is a side diagram showing the configuration example of the optical device for stereoscopic display according to the first embodiment.

FIG. 3 is a side diagram showing a configuration example of a liquid crystal display panel of the optical device for stereoscopic display shown in FIG. 1.

FIG. 4 is a block diagram showing a circuit configuration example of a stereoscopic display apparatus according to the first embodiment.

FIG. 5 is a side diagram showing a configuration example of an optical device for stereoscopic display according to a second embodiment.

FIG. 6 is a side diagram showing a configuration example of an optical device for stereoscopic display according to a third embodiment.

FIG. 7 is a side diagram showing a configuration example of an optical device for stereoscopic display according to a fourth embodiment.

FIG. 8 is a perspective diagram of a parallax barrier shown in FIG. 7 as viewed from a viewer side.

FIG. 9 is a perspective diagram of the parallax barrier shown in FIG. 7 as viewed from a liquid-crystal display panel side.

FIG. 10 is a side diagram showing a configuration example of an optical device for stereoscopic display according to a fifth embodiment.

FIG. 11 is a side diagram showing a configuration example of a liquid crystal parallax barrier of the optical device for stereoscopic display shown in FIG. 10.

FIG. 12 is a perspective diagram showing a configuration example of the liquid crystal parallax barrier of the optical device for stereoscopic display shown in FIG. 10.

FIG. 13 is a side diagram showing a configuration example of an optical device for stereoscopic display according to a sixth embodiment.

FIG. 14 is a side diagram showing a configuration example of an optical device for stereoscopic display according to another embodiment.

FIG. 15 is an explanatory diagram showing a concept of parallax-barrier-type stereoscopic display.

FIG. 16 is an explanatory diagram showing a correspondence relationship between openings of a parallax barrier and pixels of a display panel.

FIG. 17 is an explanatory diagram showing a correspondence relationship between openings of a parallax barrier and pixels of a display panel in the case that the display panel is deformed.

FIG. 18 is an explanatory diagram showing a difficulty in the case that the display panel is deformed.

### DETAILED DESCRIPTION OF THE PREFERRED EMBODIMENTS

Hereinafter, preferred embodiments of the invention will be described in detail with reference to drawings.

### First Embodiment

General configuration of optical device for stereoscopic display 10

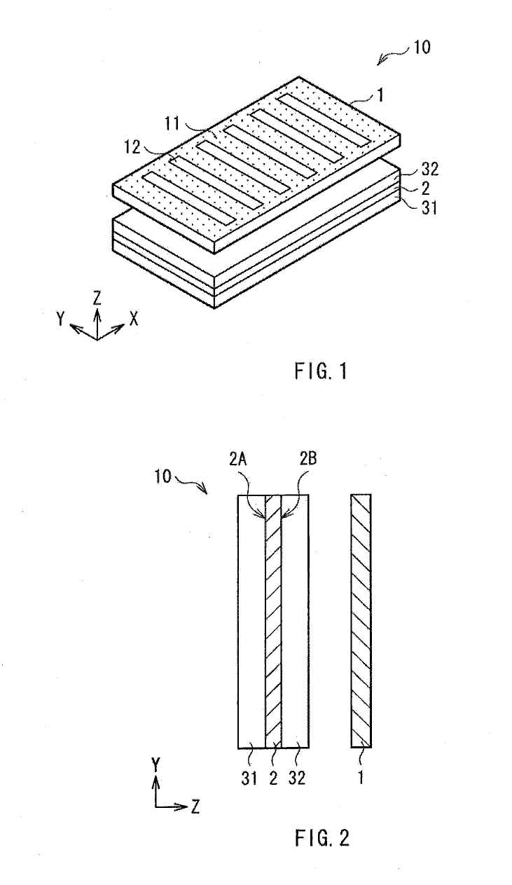

FIGS. 1 and 2 show a configuration example of an optical device for stereoscopic display 10 according to a first embodiment of the invention. The optical device for stereoscopic display 10 has a parallax barrier 1, a liquid crystal display panel 2, a first transparent parallel plate 31 and a second transparent parallel plate 32. The liquid crystal display panel 2, which corresponds to a display section for two-dimensional image display, has a first surface 2A and a second surface 2B opposed to each other. A second surface 2B side corresponds to a side (viewer side) for image display, from which displayed-image light is emitted. The parallax barrier 1, which is a parallax separation section for splitting displayed-image light from the liquid crystal display panel 2 so as to enable stereoscopy, is disposed to face the liquid crystal display panel 2 on a side of the second surface 2B.

A not-shown backlight, which emits light for image display to the liquid crystal display panel 2, may be provided on a back side (side opposite the first surface 2A) of the liquid crystal display panel 2.

Configuration of liquid crystal display panel 2

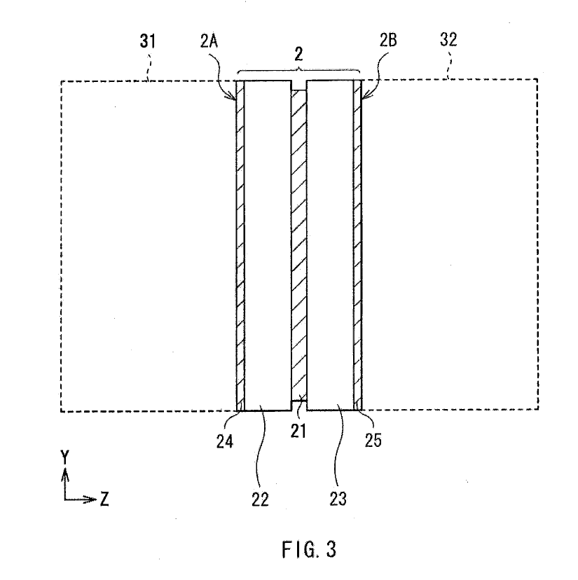

FIG. 3 shows a specific configuration example of the liquid crystal display panel 2. The liquid crystal display panel 2 has a liquid crystal layer 21, a first transparent substrate 22 and a second transparent substrate 23 including, for example, a glass material, and a first polarizing plate 24 and a second polarizing plate 25. Liquid crystal molecules including a predetermined liquid crystal material are dispersed within the liquid crystal layer 21. A not-shown transparent conductive film (pixel electrode) including, for example, ITO (Indium Tin Oxide) and a not-shown alignment film are formed between the liquid crystal layer 21 and the first transparent substrate 22. Similarly, a not-shown transparent conductive film including, for example, ITO and a not-shown alignment film are formed between the liquid crystal layer 21 and the second transparent substrate 23. The first transparent substrate 22 and the second transparent substrate 23 are oppositely disposed with the liquid crystal layer 21 in between. Furthermore, the first polarizing plate 24 and the second polarizing plate 25 are oppositely disposed outside the substrates 22 and 23, respectively. In a configuration shown in FIG. 3, a surface of the first polarizing plate 24 corresponds to the first surface 2A of the liquid crystal display panel 2, and a surface of the second polarizing plate 25 corresponds to the second surface 2B thereof.

The liquid crystal display panel 2 has a plurality of pixels, and may independently adjust the quantity of light emission of each pixel. The liquid crystal display panel 2 rotates liquid crystal molecules in the liquid crystal layer 21 by an electric field applied by a not-shown pixel electrode, and thus may rotate a polarization direction of incident light. In the liquid crystal display panel 2, the first polarizing plate 24 serves as a polarizer for light incident from a first surface 2A side, and the second polarizing plate 25 serves as an analyzer for the light.

Configuration of parallax barrier 1

The parallax barrier 1 has a light shielding section 11 and a plurality of light-transmissive slit-like openings 12 as shown in FIG. 1. The parallax barrier 1 is formed, for example, by providing a non-transmissive black substance or a reflective thin-film metal as the shading section 11 on a transparent flat plate. The parallax barrier 1 is provided parallel to the second surface 2B of the liquid crystal display panel 2. The number of the openings 12 is determined based on resolution of the liquid crystal display panel 2 and the number of visual points for stereoscopic display. For example, when resolution of the liquid crystal display panel 2 is 1920×1080 dots, and stereoscopic display is performed with 10 visual points, the number of slits of the openings 12 is 192. FIG. 1 representatively shows six openings 12 in a simplified manner.

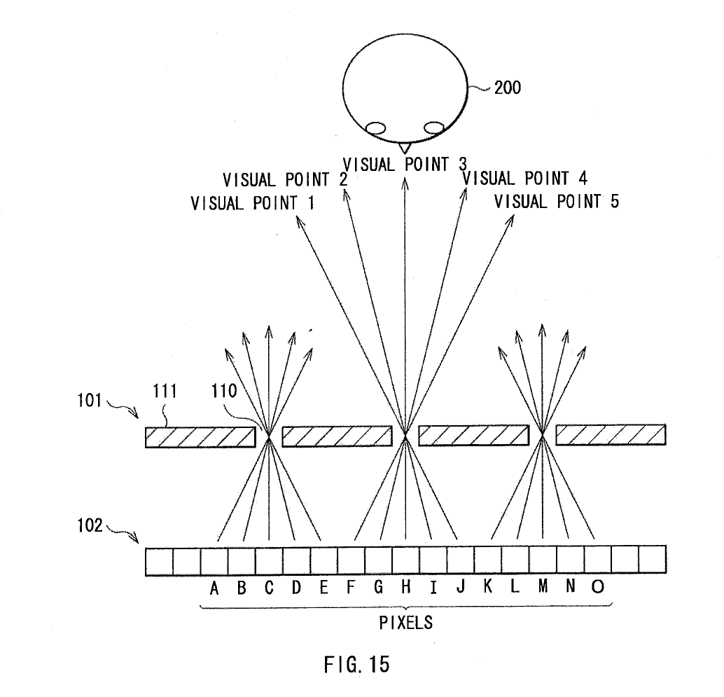

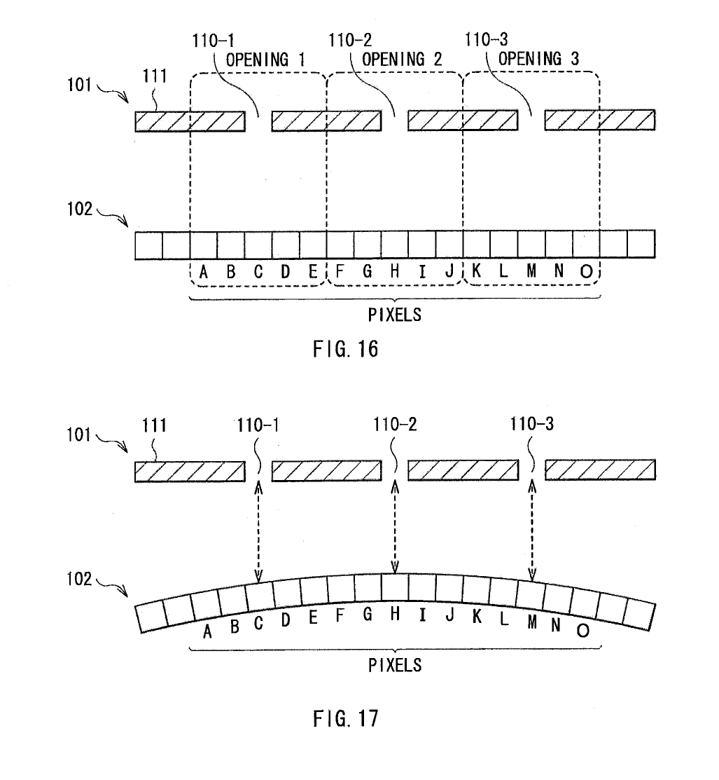

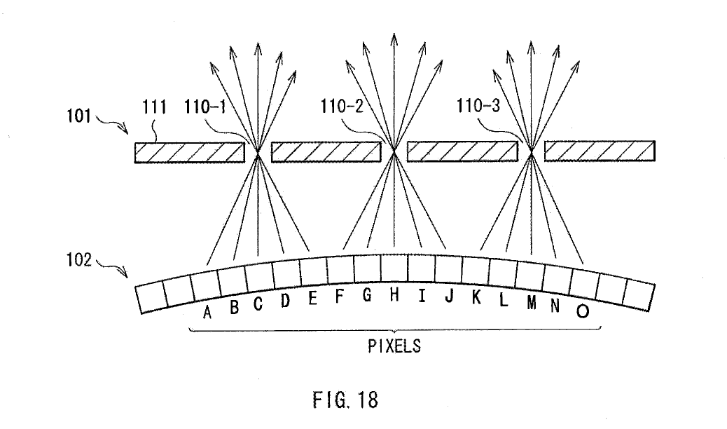

Emission angles of light emitted from a plurality of pixels of the liquid crystal display panel 2 are limited based on positional relationships between the openings 12 of the parallax barrier 1 and the pixels of the liquid crystal display panel 2. The pixels of the liquid crystal display panel 2 are different in display direction depending on the positional relationships with the openings 12. A viewer thus views different images on two eyes and thus may sense a stereoscopic image. Since the pixels are different in display direction, the liquid crystal display panel 2 displays images corresponding to display angels, enabling stereoscopy. The principle of stereoscopic display using the optical device for stereoscopic display 10 is the same as that of the typical parallax-barrier-type stereoscopic display shown in FIG. 15.

Configuration of first and second transparent parallel plates 31 and 32

The first transparent parallel plate 31 is disposed to be in contact with the first surface 2A of the liquid crystal display panel 2. Specifically, the first transparent parallel plate 31 is disposed such that the whole surface of the plate 31 is contacted over the first surface 2A. Thickness of the first transparent parallel plate 31 is preferably larger than thickness of the liquid crystal display panel 2.

The second transparent parallel plate 32 is disposed to be in contact with the second surface 2B of the liquid crystal display panel 2. Specifically, the second transparent parallel plate 32 is disposed such that the whole surface of the plate 32 is contacted over the second surface 2B. Thickness of the second transparent parallel plate 32 is preferably larger than thickness of the liquid crystal display panel 2.

The first and second transparent parallel plates 31 and 32 may be formed of, for example, a transparent glass plate or a transparent plastic material such as acryl. In the case that the transparent parallel plates are formed of a glass plate, float glass is advantageous in that flatness of the liquid crystal display panel 2 may be improved due to high flatness of the glass despite heavy weight. In addition, a glass material generally has high transmittance. In the case that the transparent parallel plates are formed of a plastic material, total weight of components may be advantageously decreased due to relatively light weight of the material.

Operation and effects

Next, description is made on operation and effects of the optical device for stereoscopic display 10, particularly, on operation and effects caused by disposing the first and second transparent parallel plates 31 and 32. In the optical device for stereoscopic display 10, the first transparent parallel plate 31 is disposed to be in contact with the first surface 2A of the liquid crystal display panel 2, and the second transparent parallel plate 32 is disposed to be in contact with the second surface 2B thereof, thereby the liquid crystal display panel 2 is planarly supported by the first and second transparent parallel plates 31 and 32. This suppresses deformation of the liquid crystal display panel 2 due to distortion, leading to improvement in flatness of the panel 2. Thus, deviation in positional relationship between each pixel of the liquid crystal display panel 2 and each opening 12 of the parallax barrier 1 is suppressed over the whole screen. According to this, when stereoscopic display is performed, image degradation such as moire or pseudoscopy may be prevented over the whole screen area, leading to good stereoscopic display. Particularly, even if a relatively large (large-screen) stereoscopic display apparatus is configured, high-image-quality stereoscopic display may be achieved over the whole screen area.

Particularly, thickness of each of the first and second transparent parallel plates 31 and 32 is made larger than thickness of the liquid crystal display panel 2, and therefore deformation of the panel 2 may be more effectively suppressed.

Boundary between first or second transparent parallel plate 31 or 32 and liquid crystal display panel 2

The embodiment is not limited to a configuration where the first or second transparent parallel plate 31 or 32 is directly adherently contacted to the liquid crystal display panel 2, and may be configured such that each transparent parallel plate is adhered to the liquid crystal display panel 2 with a thin film such as an adhesion layer in between, the thin film having a sufficiently small thickness compared with each of the first and second transparent parallel plates 31 and 32 or the liquid crystal display panel 2. In consideration of such a state, a formation method of a boundary between the first or second transparent parallel plate 31 or 32 and the liquid crystal display panel 2 is roughly divided into two methods.

As one formation method, an air layer is provided in the boundary. In this case, since refractive index of the first or second transparent parallel plate 31 or 32 is different from that of air, and refractive index of the liquid crystal display panel 2 is different from that of air, light loss occurs. To reduce the light loss, a thin film for refractive-index matching with air can be formed on a surface of the first or second transparent parallel plate 31 or 32 or on a surface of the liquid crystal display panel 2.

As the other formation method, it is conceivable that each of the first and second transparent parallel plates 31 and 32 is bonded to the liquid crystal display panel 2 by a bonding or adhesive agent. In this case, the bonding or adhesive agent preferably has a refractive index similar to a refractive index of a material forming the first or second transparent parallel plate 31 or 32 and similar to a refractive index of a material forming each of a first-surface 2A side portion and a second-surface 2B side portion of the liquid crystal display panel 2. A material having a refractive index similar to that of the first or second transparent parallel plate 31 or 32 and to that of the panel 2 is filled for bonding, and therefore light loss may be reduced. Particularly, use of an acrylic or epoxy UV adhesive, which becomes transparent by UV irradiation, may prevent light loss in an adhesive portion, leading to a high-luminance display apparatus.

Application example to stereoscopic display apparatus

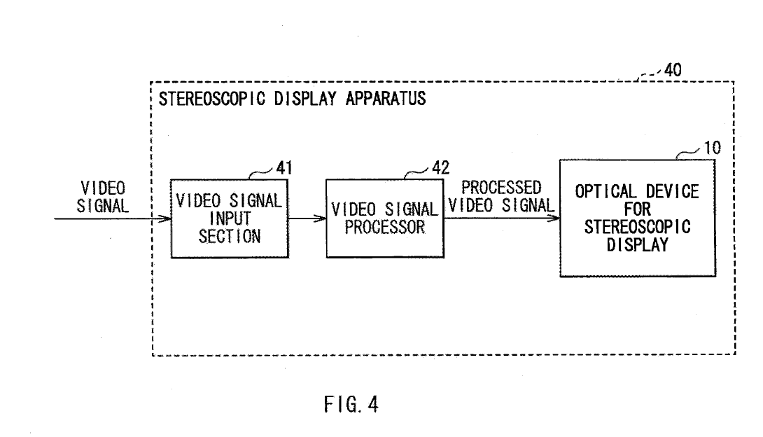

FIG. 4 shows a circuit configuration example of a stereoscopic display apparatus 40 using the optical device for stereoscopic display 10 as described above. The stereoscopic display apparatus 40 has a video signal input section 41 and a video signal processor 42.

The video signal input section 41 receives a video signal from a video-signal generating device or an external antenna. The video signal processor 42 allows the optical device for stereoscopic display 10 to display an image based on a video signal inputted via the video signal input section 41. When the optical device for stereoscopic display 10 performs stereoscopic display, each pixel need to display an image corresponding to a visual point determined by a positional relationship between each opening 12 of the parallax barrier 1 and each pixel of the liquid crystal display panel 2. Therefore, the video signal processor 42 rearranges externally-inputted video signals along visual points corresponding to respective pixels and supplies such converted signals to the liquid crystal display panel 2. Accordingly, the optical device for stereoscopic display 10 may perform appropriate stereoscopic display.

### Second Embodiment

Next, an optical device for stereoscopic display according to a second embodiment of the invention is described. Substantially the same components as those of the optical device for stereoscopic display 10 according to the first embodiment are designated by the same symbols, and description of them is appropriately omitted. The optical device for stereoscopic display according to the second embodiment may be also applied to the stereoscopic display apparatus 40 shown in FIG. 4.

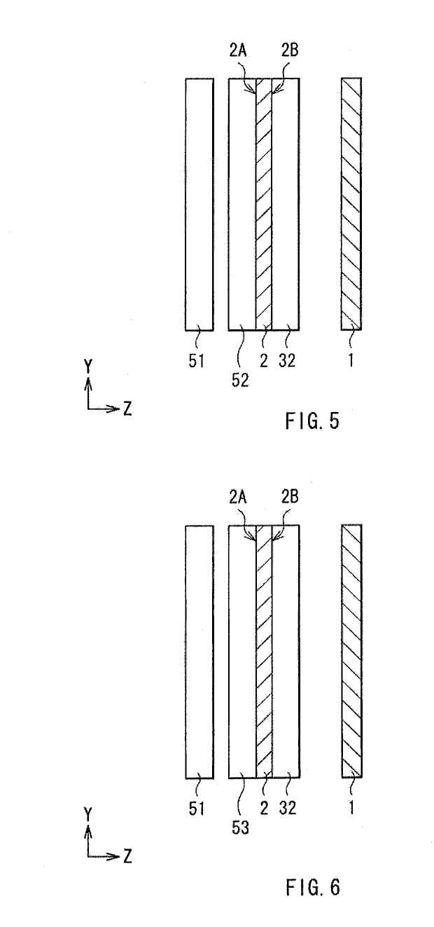

FIG. 5 shows a configuration example of an optical device for stereoscopic display according to the embodiment. The optical device for stereoscopic display has a light source 51, which emits light for image display to a liquid crystal display panel 2, on a back side (side opposite a first surface 2A) of the panel 2. The light source 51 is a light emitter such as CCFL (Cold Cathode Fluorescent Lamp) or LED (Light Emitting Diode).

Moreover, the optical device for stereoscopic display has a light guide plate 52 between the light source 51 and the panel 2. The light guide plate 52 guides light from the light source 51 to a first surface 2A side of the liquid crystal display panel 2 and outputs the light. The light guide plate 52 is formed of a transparent substance such as acrylic resin.

In the embodiment, the light guide plate 52 further has a function of the first transparent parallel plate 31 of the first embodiment. Therefore, the light guide plate 52 is disposed to be in contact with the first surface 2A of the liquid crystal display panel 2 in the same way as the first transparent parallel plate 31. Specifically, the light guide plate 52 is disposed such that the whole surface of the plate 52 is contacted over the first surface 2A. Accordingly, the liquid crystal display panel 2 is planarly supported by the light guide plate 52 and the second transparent parallel plate 32, which suppresses deformation of the liquid crystal display panel 2 due to distortion, leading to improvement in flatness of the panel 2. Thickness of the light guide plate 52 is preferably larger than thickness of the liquid crystal display panel 2.

According to the embodiment, the light guide plate 52 also serves as the first transparent parallel plate 31, and therefore the number of components of a device may be decreased, leading to reduction in cost and weight.

In the embodiment, the same method as the formation method of a boundary between each of the first and second transparent parallel plates 31 and 32 and the liquid crystal display panel 2 described in the first embodiment may be used as a formation method of a boundary between the light guide plate 52 and the liquid crystal display panel 2.

### Third Embodiment

Next, an optical device for stereoscopic display according to a third embodiment of the invention is described. Substantially the same components as those of the optical device for stereoscopic display 10 according to the first embodiment are designated by the same symbols, and description of them is appropriately omitted. The optical device for stereoscopic display according to the third embodiment may be also applied to the stereoscopic display apparatus 40 shown in FIG. 4.

FIG. 6 shows a configuration example of an optical device for stereoscopic display according to the embodiment. The optical device for stereoscopic display has a light source 51, which emits light for image display to a liquid crystal display panel 2, on a back side (side opposite a first surface 2A) of the panel 2. The light source 51 is a light emitter such as CCFL or LED.

Moreover, the optical device for stereoscopic display has a diffuser plate 53 between the light source 51 and the panel 2. The diffuser plate 53 scatters light from the light source 51 and outputs the scattered light to a first surface 2A side of the liquid crystal display panel 2. The diffuser plate 53 adjusts light from the light source 51 to be uniformly distributed on the liquid crystal display panel 2. The diffuser plate 53 is formed of a transparent substance such as acrylic resin.

In the embodiment, the diffuser plate 53 further has a function of the first transparent parallel plate 31 of the first embodiment. Therefore, the diffuser plate 53 is disposed to be in contact with the first surface 2A of the liquid crystal display panel 2 in the same way as the first transparent parallel plate 31. Specifically, the diffuser plate 53 is disposed such that the whole surface of the plate 53 is contacted over the first surface 2A. Accordingly, the liquid crystal display panel 2 is planarly supported by the diffuser plate 53 and the second transparent parallel plate 32, which suppresses deformation of the liquid crystal display panel 2 due to distortion, leading to improvement in flatness of the panel 2. Thickness of the diffuser plate 53 is preferably larger than thickness of the liquid crystal display panel 2.

According to the embodiment, the diffuser plate 53 also serves as the first transparent parallel plate 31, and therefore the number of components of a device may be decreased, leading to reduction in cost and weight.

In the embodiment, the same method as the formation method of a boundary between each of the first and second transparent parallel plates 31 and 32 and the liquid crystal display panel 2 described in the first embodiment may be used as a formation method of a boundary between the diffuser plate 53 and the liquid crystal display panel 2.

### Fourth Embodiment

Next, an optical device for stereoscopic display according to a fourth embodiment of the invention is described. Substantially the same components as those of the optical device for stereoscopic display 10 according to the first embodiment are designated by the same symbols, and description of them is appropriately omitted. The optical device for stereoscopic display according to the fourth embodiment may be also applied to the stereoscopic display apparatus 40 shown in FIG. 4.

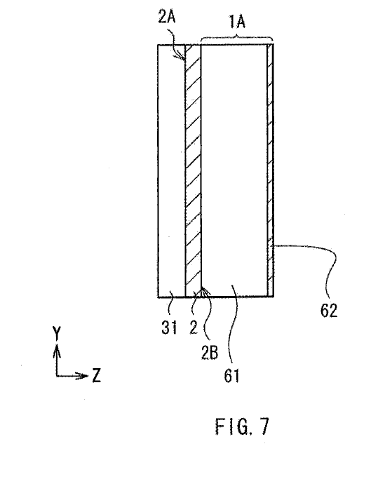

FIG. 7 shows a configuration example of an optical device for stereoscopic display according to the embodiment. The optical device for stereoscopic display has a parallax barrier 1A having a transparent substrate 61 in place of the parallax barrier 1 of the first embodiment.

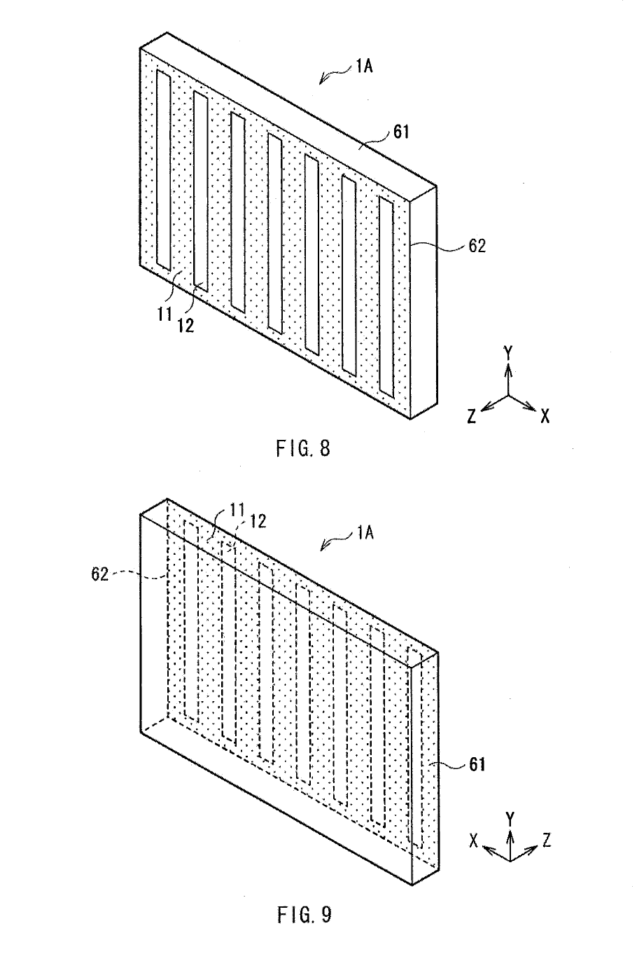

FIG. 8 shows a configuration of the parallax barrier 1A as viewed from a viewer side, and FIG. 9 shows a configuration of the parallax barrier 1A as viewed from a liquid crystal display panel 2 side. The transparent substrate 61 of the parallax barrier 1A includes a flat plate having a certain thickness. The transparent substrate 61 may be formed of, for example, a transparent glass plate or a transparent plastic material such as acryl. One surface (viewer-side surface) of the transparent substrate 61 has a light-absorbing black mask layer 62 formed thereon. The mask layer 62 has a shading section 11 and a plurality of slit-like openings 12 as in the parallax barrier 1. The mask layer 62 may be formed by a printing process of ink or the like, or a partial etching process of a thin film such as chromium film.

In the embodiment, the transparent substrate 61 of the parallax barrier 1A further has a function of the second transparent parallel plate 32 of the first embodiment. Therefore, the transparent substrate 61 is disposed to be in contact with a second surface 2B of the liquid crystal display panel 2 in the same way as the second transparent parallel plate 32. Specifically, the transparent substrate 61 is disposed such that the whole surface of the substrate 61 (surface opposite the mask layer 62) is contacted over the second surface 2B. Accordingly, the liquid crystal display panel 2 is planarly supported by the transparent substrate 61 and the first transparent parallel plate 31, which suppresses deformation of the liquid crystal display panel 2 due to distortion, leading to improvement in flatness of the panel 2. Thickness of the transparent substrate 61 is preferably larger than thickness of the liquid crystal display panel 2.

According to the embodiment, the transparent substrate 61 of the parallax barrier 1A also serves as the second transparent parallel plate 32, thereby the number of components of a device may be decreased, leading to reduction in cost and weight.

In the embodiment, the same method as the formation method of a boundary between each of the first and second transparent parallel plates 31 and 32 and the liquid crystal display panel 2 described in the first embodiment may be used as a formation method of a boundary between the transparent substrate 61 and the liquid crystal display panel 2.

### Fifth embodiment

Next, an optical device for stereoscopic display according to a fifth embodiment of the invention is described. Substantially the same components as those of the optical device for stereoscopic display 10 according to the first embodiment are designated by the same symbols, and description of them is appropriately omitted. The optical device for stereoscopic display according to the fifth embodiment may be also applied to the stereoscopic display apparatus 40 shown in FIG. 4.

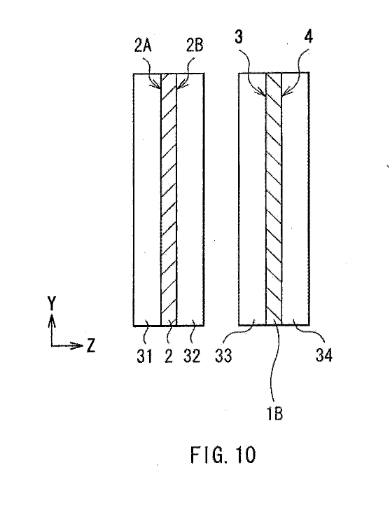

FIG. 10 shows a configuration example of an optical device for stereoscopic display according to the embodiment. The optical device for stereoscopic display has a liquid-crystal parallax barrier 1B in place of the parallax barrier 1 of the first embodiment. The liquid-crystal parallax barrier 1B has a third surface 3 and a fourth surface 4 opposed to each other. Moreover, the optical device for stereoscopic display has a third transparent parallel plate 33 and a fourth transparent parallel plate 34. Configurations of a liquid crystal display panel 2, a first transparent parallel plate 31 and a second transparent parallel plate 32 are the same as in the first embodiment.

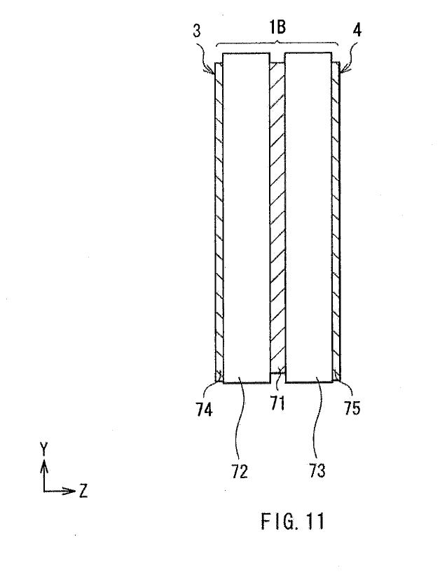

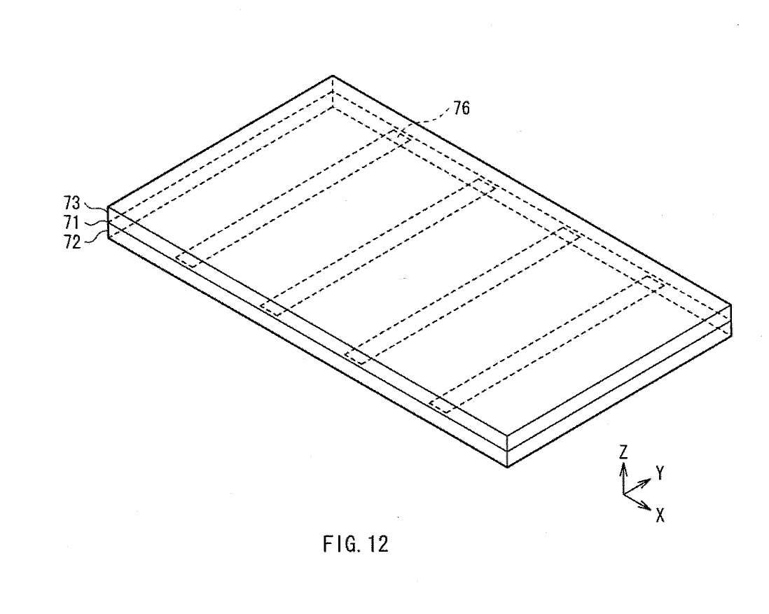

FIGS. 11 and 12 show a specific configuration example of the liquid-crystal parallax barrier 1B. The liquid-crystal parallax barrier 1B has a liquid crystal layer 71, a first transparent substrate 72 and a second transparent substrate 73, the substrates including, for example, a glass material, and a first polarizing plate 74 and a second polarizing plate 75. Liquid crystal molecules including a predetermined liquid crystal material are dispersed within the liquid crystal layer 71.

The first transparent substrate 72 and the second transparent substrate 73 are oppositely disposed with the liquid crystal layer 71 in between. Furthermore, the first polarizing plate 74 and the second polarizing plate 75 are oppositely disposed outside the substrates 72 and 73, respectively. In a configuration shown in FIG. 11, a surface of the first polarizing plate 74 corresponds to the third surface 3 of the liquid-crystal parallax barrier 1B, and a surface of the second polarizing plate 75 corresponds to the fourth surface 4 thereof.

A transparent ITO electrode, which is not shown in FIG. 11, is formed between the liquid crystal layer 71 and the second transparent substrate 73, and similarly formed between the liquid crystal layer 71 and the first transparent substrate 72. Furthermore, a not-shown alignment film is formed between the liquid crystal layer 71 and the second transparent substrate 73, and formed between the liquid crystal layer 71 and the first transparent substrate 72. As the ITO electrode, striped ITO electrodes 76 are formed, for example, as shown in FIG. 12. In FIG. 12, only ITO electrodes 76 on a side of the second transparent substrate 73 are representatively shown. In FIG. 12, the first polarizing plate 74 and the second polarizing plate 75 are omitted to be shown.

In the liquid-crystal parallax barrier 1B, voltage is externally applied to the striped ITO electrodes 76 as shown in FIG. 12. An electric field is generated within the liquid crystal layer 71 in response to the voltage application, resulting in change in tilt of liquid crystal molecules enclosed in the layer. A combination of the first polarizing plate 74 and the second polarizing plate 75 is provided, and therefore the liquid-crystal parallax barrier 1B may changeably operate to be transmissive or absorptive (shady) with respect to incident light depending on externally applied voltage.

The first and second polarizing plates 74 and 75 perpendicularly cross each other in a transmission axis direction, and are thus set in a so-called crossed nicols state. A liquid crystal material enclosed in the liquid crystal layer 71 is aligned in a TN (Twisted Nematic) mode. In such a configuration, when voltage is not applied, the liquid-crystal parallax barrier 1B operates to be transmissive with respect to incident light over the whole area. In this case, while the liquid-crystal parallax barrier 1B does not operate as a parallax barrier, the barrier 1B may perform plane display (2D display) by displaying only a two-dimensional image corresponding to a particular visual point on the liquid crystal display panel 2.

When voltage is applied to the striped ITO electrodes 76 as shown in FIG. 12, a tilt of liquid crystal molecules directly under the ITO electrodes 76 is changed. Consequently, light from the liquid crystal display panel 2 passes through only portions where the ITO electrodes 76 do not exist, and consequently the liquid-crystal parallax barrier 1B operates as a parallax barrier. In other words, when voltage is applied, the liquid-crystal parallax barrier 1B operates as the shading section 11 of the parallax barrier 1 in FIG. 1 in a region corresponding to portions where the ITO electrodes 76 are formed, and operates as the openings 12 in a region corresponding to portions where the ITO electrodes 76 are not formed. In this case, a three-dimensional image corresponding to a plurality of visual points is displayed on pixels of the liquid crystal display panel 2, enabling 3D (stereoscopic) display. In other words, in the embodiment, the liquid-crystal parallax barrier 1B may be operated as a switching barrier, which enables switching between 2D display and 3D display.

In the embodiment, since not only the liquid crystal display panel 2 but also the liquid-crystal parallax barrier 1B as a parallax separation section is formed of a liquid crystal element, the barrier 1B itself is small in thickness and therefore easily deformed by its own weight as in the liquid crystal display panel 2. To prevent this, in the embodiment, the liquid-crystal parallax barrier 1B is configured to be planarly supported by the third and fourth transparent parallel plates 33 and 34 as shown in FIG. 10.

The third transparent parallel plate 33 is disposed to be in contact with the third surface 3 of the liquid-crystal parallax barrier 1B. Specifically, the third transparent parallel plate 33 is disposed such that the whole surface of the plate 33 is contacted over the third surface 3. Thickness of the third transparent parallel plate 33 is preferably larger than thickness of the liquid-crystal parallax barrier 1B.

The fourth transparent parallel plate 34 is disposed to be in contact with the fourth surface 4 of the liquid-crystal parallax barrier 1B. Specifically, the fourth transparent parallel plate 34 is disposed such that the whole surface of the plate 34 is contacted over the fourth surface 4. Thickness of the fourth transparent parallel plate 34 is preferably larger than thickness of the liquid-crystal parallax barrier 1B.

According to the embodiment, not only deformation of the liquid crystal display panel 2 but also deformation of the liquid-crystal parallax barrier 1B as a parallax separation section is suppressed, leading to improvement in flatness of the liquid-crystal parallax barrier 1B in addition to the liquid crystal display panel 2. Accordingly, while a parallax separation section is formed of a liquid crystal element, deviation in positional relationship between each pixel of the liquid crystal display panel 2 and each opening 12 of the liquid-crystal parallax barrier 1B is suppressed over the whole screen. According to this, when stereoscopic display is performed, image degradation such as moire or pseudoscopy may be prevented over the whole screen area, leading to good stereoscopic display. Particularly, even if a relatively large (large-screen) stereoscopic display apparatus is configured, high-image-quality stereoscopic display may be achieved over the whole screen area.

In addition, a parallax separation section is formed of a liquid crystal element, which enables switching between two-dimensional display and three-dimensional display.

In the embodiment, the same method as the formation method of a boundary between each of the first and second transparent parallel plates 31 and 32 and the liquid crystal display panel 2 described in the first embodiment may be used as a formation method of a boundary between each of the third and fourth transparent parallel prates 33 and 34 and the liquid-crystal parallax barrier 1B.

### Sixth Embodiment

Next, an optical device for stereoscopic display according to a sixth embodiment of the invention is described. Substantially the same components as those of the optical device for stereoscopic display 10 according to the first embodiment are designated by the same symbols, and description of them is appropriately omitted. The optical device for stereoscopic display according to the sixth embodiment may be also applied to the stereoscopic display apparatus 40 shown in FIG. 4.

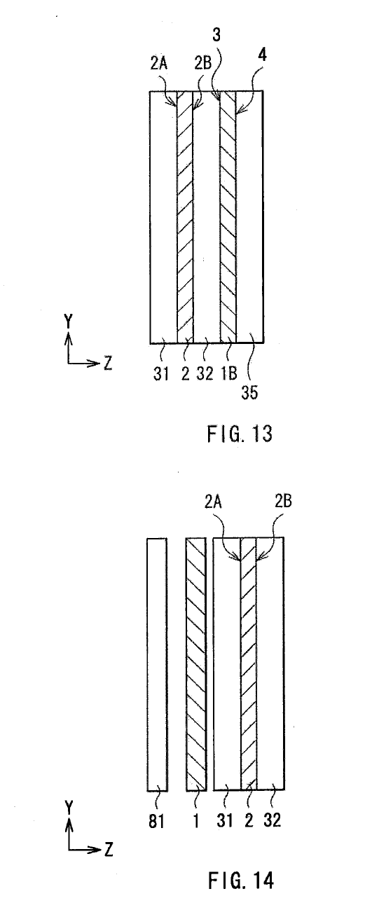

FIG. 13 shows a configuration example of an optical device for stereoscopic display according to the embodiment. The optical device for stereoscopic display has a liquid-crystal parallax barrier 1B in place of the parallax barrier 1 of the first embodiment. The liquid-crystal parallax barrier 1B has the same configuration as that of the fifth embodiment (FIGS. 11 and 12), where a third surface 3 and a fourth surface 4 opposed to each other are provided. Moreover, the optical device for stereoscopic display has a third transparent parallel plate 35. Configurations of a liquid crystal display panel 2 and a first transparent parallel plate 31 are the same as in the first embodiment.

In the embodiment, a second transparent parallel plate 32 is disposed to be in contact with a second surface 2B of a liquid crystal display panel 2, and contacted to a third surface 3 of the liquid-crystal parallax barrier 1B. Specifically, the second transparent parallel plate 32 is disposed such that the entire surface of one surface of the plate 32 is contacted over the second surface 2B, and the entire surface of the other surface is contacted over the third surface 3. Thickness of the second transparent parallel plate 32 is preferably larger than thickness of the liquid crystal display panel 2 and of the liquid-crystal parallax barrier 1B.

A third transparent parallel plate 35 is disposed to be in contact with a fourth surface 4 of the liquid-crystal parallax barrier 1B. Specifically, the third transparent parallel plate 35 is disposed such that the whole surface of the plate 35 is contacted over the fourth surface 4. Thickness of the third transparent parallel plate 35 is preferably larger than thickness of the liquid-crystal parallax barrier 1B.

In the embodiment, the liquid crystal display panel 2 is planarly supported by the first and second transparent parallel plates 31 and 32, and the liquid-crystal parallax barrier 1B is planarly supported by the second and third transparent parallel plates 32 and 35.

According to the embodiment, as in the fifth embodiment, not only deformation of the liquid crystal display panel 2 but also deformation of the liquid-crystal parallax barrier 1B as a parallax separation section is suppressed, leading to improvement in flatness of the liquid-crystal parallax barrier 1B in addition to the liquid crystal display panel 2. Accordingly, while a parallax separation section is formed of a liquid crystal element, deviation in positional relationship between each pixel of the liquid crystal display panel 2 and each opening 12 of the liquid-crystal parallax barrier 1B is suppressed over the whole screen.

According to the embodiment, the same advantage as in the fifth embodiment may be obtained in this way. Furthermore, since the number of transparent parallel plates may be decreased by one compared with the fifth embodiment; the number of components of a device may be decreased, leading to reduction in cost and weight. Moreover, assembling adjustment may be simplified.

In the embodiment, the same method as the formation method of a boundary between each of the first and second transparent parallel plates 31 and 32 and the liquid crystal display panel 2 described in the first embodiment may be used as a formation method of a boundary between each of the second and third transparent substrates 32 and 35 and the liquid-crystal parallax barrier 1B:

### Other embodiments

The invention is not limited to the above embodiments, and various modifications and alterations may be made. For example, while the embodiments have been described with a parallax barrier type as an example, the invention may be also applied to a lenticular type using a lenticular lens as a parallax separation section. In such a case, the invention may be applied to an apparatus with a lenticular element formed of a liquid crystal element as described in JP-T-2000-503424.

While the embodiments have been described with a case, as an example, where a display section is formed of the liquid crystal display panel 2, other type of display panels may be used. For example, an electroluminescence display panel or a plasma display may be used.

Moreover, a configuration as an appropriate combination of the embodiments may be used. For example, while the second embodiment (FIG. 5) has been configured such that the light guide plate 52 also serves as the first transparent parallel plate 31 in the first embodiment, the embodiment may be configured such that the light guide plate 52 and the first transparent parallel plate 31 are formed as separate members. In other words, in the configuration of FIG. 5, a first transparent parallel plate 31 may be disposed as a separate member between the light guide plate 52 and the liquid crystal display panel 2. In this case, since two members, the first transparent parallel plate 31 and the light guide plate 52, are planarly disposed on a first surface 2A side of the liquid crystal display panel 2, deformation of the panel 2 may be more effectively suppressed.

While the embodiments have been described with a case, as an example, where a parallax separation section is oppositely disposed on a display surface side (second surface 2B side) of a display section, the parallax separation section may be oppositely disposed on a side (first surface 2A side) opposite to the display surface side, particularly, in the case that the display section is a backlight-type non-self-luminous display. FIG. 14 shows an example of such a configuration. In the configuration example, a parallax barrier 1 is disposed between a liquid crystal display panel 2 and a light source 81 as a backlight of the panel 2. Other configurations are the same as in the configuration example of FIG. 2.

The present application contains subject matter related to that disclosed in Japanese Priority Patent Application JP 2010-135160 filed in the Japan Patent Office on Jun. 14, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalent thereof

What is claimed is:

1. An optical device for stereoscopic display comprising:
a display section having a first surface and a second surface opposed to each other and outputting displayed-image light from the second surface;
a parallax separation section disposed to face the second surface of the display section, and splitting the displayed-image light from the display section to allow stereoscopy;
a first transparent parallel plate disposed to be in contact with the first surface of the display section; and
a second transparent parallel plate disposed to be in contact with the second surface of the display section.

2. The optical device for stereoscopic display according to claim 1,
wherein a whole surface of the first transparent parallel plate is in contact with the first surface of the display section, and
a whole surface of the second transparent parallel plate is in contact with the second surface of the display section.

3. The optical device for stereoscopic display according to claim 1,
wherein the display section is configured of a liquid crystal display panel.

4. The optical device for stereoscopic display according to claim 3,
wherein the liquid crystal display panel includes a liquid crystal layer, a first polarizing plate and a second polarizing plate, the first and second polarizing plates facing each other with the liquid crystal layer in between, the first polarizing plate having a surface corresponding to the first surface of the display section and the second polarizing plate having a surface corresponding to the second surface of the display section.

5. The optical device for stereoscopic display according to claim 1,
wherein thickness of each of the first transparent parallel plate and the second transparent parallel plate is larger than total thickness of the display section.

6. The optical device according to claim 1,
wherein one or both of the first and second transparent parallel plates is formed of a glass material.

7. The optical device for stereoscopic display according to claim 1,
wherein one or both of the first and second transparent parallel plates is formed of a plastic material.

8. The optical device for stereoscopic display according to claim 1,
wherein the first transparent parallel plate is configured of a light-guide plate which leads received light to a first-surface of the display section.

9. The optical device for stereoscopic display according to claim 1,
wherein the first transparent parallel plate is configured of a diffusing plate which diffuses received light and leads the resultant diffused-light to a first-surface of the display section.

10. The optical device for stereoscopic display according to claim 1, wherein the parallax separation section has a transparent substrate which is in contact with the second surface of the display section and also serves as the second transparent parallel plate.

11. The optical device for stereoscopic display according to claim 1,
wherein the parallax separation section is configured of a liquid crystal element having a third surface and a fourth surface opposed to each other, and
the optical device for stereoscopic display further includes:
a third transparent parallel plate disposed to be in contact with the third surface of the parallax separation section; and
a fourth transparent parallel plate disposed to be in contact with the fourth surface of the parallax separation section.

12. The optical device for stereoscopic display according to claim 1,
wherein the parallax separation section is configured of a liquid crystal element having a third surface and a fourth surface opposed to each other, and
the second transparent parallel plate is in contact with the third surface of the parallax separation section as well as the second surface of the display section.

13. The optical device for stereoscopic display according to claim 12 further comprising another transparent parallel plate disposed to be in contact with the fourth surface of the parallax separation section.

14. A device for stereoscopic display comprising:
a light source;
a display section having a first surface and a second surface opposed to each other and outputting displayed-image light from the second surface;
a parallax separation section disposed between the light source and the first surface of the display section, and splitting the displayed-image light from the display section to allow stereoscopy;
a first transparent parallel plate disposed to be in contact with the first surface of the display section; and
a second transparent parallel plate disposed to be in contact with the second surface of the display section.

15. A device for stereoscopic display comprising:
a display section having a first surface and a second surface opposed to each other and outputting displayed-image light from the second surface;
a parallax separation section disposed to face the second surface of the display section, and having a light shielding section and a plurality of light-transmissive openings;
a first transparent parallel plate disposed to be in contact with the first surface of the display section; and
a second transparent parallel plate disposed to be in contact with the second surface of the display section.

16. A stereoscopic display apparatus comprising:
an optical device for stereoscopic display; and
a signal processor allowing the optical device for stereoscopic display to display images based on inputted video signals,
wherein the optical device for stereoscopic display includes,
a display section having a first surface and a second surface opposed to each other and outputting displayed-image light from the second surface;
a parallax separation section disposed to face the second surface of the display section, and splitting the displayed-image light from the display section to allow stereoscopy;
a first transparent parallel plate disposed to be in contact with the first surface of the display section; and
a second transparent parallel plate disposed to be in contact with the second surface of the display section.

17. A display apparatus comprising:
a display section having a first surface and a second surface opposed to each other and outputting displayed-image light from the second surface;
a separation section disposed to face the second surface of the display section,;
a first transparent parallel plate disposed to be in contact with the first surface of the display section; and
a second transparent parallel plate disposed to be in contact with the second surface of the display section.

18. A display apparatus comprising:
a light source;
a display section having a first surface and a second surface opposed to each other and outputting displayed-image light from the second surface;
a separation section disposed between the light source and the first surface of the display section,
a first transparent parallel plate disposed to be in contact with the first surface of the display section; and
a second transparent parallel plate disposed to be in contact with the second surface of the display section.
